(19) United States
(12) Patent Application Publication
(10) Pub. No.: US 2024/0345359 A1
(43) Pub. Date: Oct. 17, 2024

(54) CAMERA MODULE AND UNMANNED AERIAL VEHICLE

(71) Applicant: Arashi Vision Inc., Shenzhen (CN)

(72) Inventors: Guilin ZHANG, Shenzhen (CN); Lei ZHANG, Shenzhen (CN); Fei GAO, Shenzhen (CN)

(73) Assignee: Arashi Vision Inc., Shenzhen (CN)

(21) Appl. No.: 18/755,687

(22) Filed: Jun. 27, 2024

Related U.S. Application Data
(63) Continuation of application No. PCT/CN2022/143691, filed on Dec. 30, 2022.

(30) Foreign Application Priority Data
Dec. 31, 2021 (CN) 202111671006.8
Dec. 31, 2021 (CN) 202123447298.5

(51) Int. Cl. G02B 7/04; G03B 15/00; G03B 30/00

(52) U.S. Cl. CPC G02B 7/04; G03B 15/006; G03B 30/00

(57) ABSTRACT

Embodiments of the present invention relate to the technical field of unmanned aerial vehicles, and particularly disclose a camera module and an unmanned aerial vehicle. The camera module comprises: a mounting frame; a lens assembly movably arranged on the mounting frame, the lens assembly comprising at least two lens modules; a driving mechanism arranged on the mounting frame, the driving mechanism comprising a guide assembly, a transmission assembly, and a driving part, the guide assembly being arranged on the mounting frame and the two lens modules being slidably fitted with the guide assembly; the transmission assembly is in transmission connection with the two lens modules, respectively; the driving part is in transmission connection with the transmission assembly, and the driving part is used for driving the two lens modules to move back and forth along the guide assembly, respectively.

### CROSS-REFERENCE TO RELATED APPLICATIONS

This application is a continuation of International Application No. PCT/CN2022/143691, with an international filing date of Dec. 30, 2022, which is based upon and claims priority to Chinese Patent Application No. 202111671006.8, filed with the Chinese Patent Office on Dec. 31, 2021, titled “Camera module and unmanned aerial vehicle”, and Chinese Patent Application No. 202123447298.5, filed with the Chinese Patent Office on Dec. 31, 2021, titled “Camera module and unmanned aerial vehicle”, the entire contents of each are incorporated herein by reference.

### TECHNICAL FIELD

Embodiments of the present invention relate to the technical field of unmanned aerial vehicles, in particular to a camera module and an unmanned aerial vehicle.

### BACKGROUND

Unmanned aerial vehicles (UAVs, or drones) are a new type of mechanical equipment in rapid development. UAVs have the advantages of small size, light weight, high safety, flexible maneuverability, fast response, unmanned, and low operation requirements. UAVs can be widely used in aerial photography, film and television, monitoring, search and rescue, resource exploration and other fields.

In order to realize functions such as drone aerial photography, UAVs generally include a camera module. The camera module often includes a lens and an image information processing module. The lens is connected to the image information processing module, and for the convenience of image acquisition, the lens is often placed outside the UAV. Since UAVs generally fly at relative high speed, as a result, the lens can be easily damaged.

### BRIEF SUMMARY

In accordance with various embodiments, a camera module and a UAV (or a drone) can drive multiple lens modules to move. The camera module can include: a mounting frame, a lens assembly and a driving mechanism. The lens assembly is movably arranged on a mounting frame, and the lens assembly includes at least two lens modules. The driving mechanism can be arranged on the mounting frame, and the driving mechanism can include a guide assembly, a transmission assembly and a driving part. The guide assembly can be arranged on the mounting frame, and the two lens modules can be slidably fitted to the guide assembly. The transmission assembly can be in transmission connection with the two lens modules respectively, the driving part can be in transmission connection with the transmission assembly, and the driving part can be used to drive the two lens modules to move back and forth along the guide assembly respectively.

Optionally, the transmission assembly includes: a first threaded rod, a second threaded rod and a speed change structure. The first threaded rod is rotatably disposed on the mounting frame, and the first threaded rod is threadedly connected with a first lens module. The second threaded rod is rotatably disposed on the mounting frame, and the second threaded rod is threadedly connected with a second lens module. The speed change structure (or speed shift structure or transmission structure) can be provided with an input end and two output ends, the driving part is connected to the input end of the speed change structure, and the two output ends of the speed change structure are in transmission connection with the first threaded rod and the second threaded rod respectively. The speed change structure can be used to adjust the rotation speed of the first threaded rod and the second threaded rod.

Optionally, the first threaded rod is provided with a positive thread, and the second threaded rod is provided with a reverse thread. The speed change structure includes an output wheel and a speed change gear set, the two ends of the speed change gear set are connected with the driving part and the output wheel respectively, and the two ends of the output wheel are connected with the first threaded rod and the second threaded rod respectively.

Optionally, the speed change structure includes a first bevel gear, a second bevel gear, a third bevel gear and a speed change gear set. One end of the speed change gear set is connected to the driving part, and the other end of the speed change gear set is connected with the first bevel gear. The first bevel gear is engaged with the second bevel gear and the third bevel gear respectively. The second bevel gear is connected with the first threaded rod, and the third bevel gear is connected with the second threaded rod.

Optionally, the transmission assembly includes a worm gear and a worm, wherein the worm is connected to the driving part, the worm is meshed with the worm gear, and the worm gear is connected to an input end of the speed change structure.

Optionally, the lens assembly further includes a first lens mount and a second lens mount, wherein the first lens mount is provided with a first lens module, and the second lens mount is provided with a second lens module. Moreover, the first lens mount is provided with a first screw hole, the first threaded rod is screwed and passes through the first screw hole, the second lens mount is provided with a second screw hole, and the second threaded rod is screwed and passes through the second screw hole.

Optionally, the guide assembly includes a first guide rod, wherein the first guide rod is fixed to the mounting frame, and the first guide rod is parallel to the first threaded rod. The first lens mount is provided with a first guide hole, and the first guide rod passes through the first guide hole.

Optionally, the first lens mount includes a first sliding plate and a first support rod, wherein the first screw hole and the first guide hole are both provided on the first sliding plate, and the first sliding plate and the first limiting plate are located between the first top plate and the first base plate of the mounting frame. One end of the first support rod is fixed on a surface of the first sliding plate facing the first top plate of the mounting frame, and the other end of the first support rod is fixed to the first lens module.

Optionally, the first lens mount further includes a first limiting plate, one end of the first support rod is connected to the first sliding plate and the first limiting plate respectively. The first sliding plate and first limiting plate are both located between the first top plate and the first base plate of the mounting frame. The first limiting plate is provided with a third guide hole, and the first guide rod passes through the third guide hole.

According to an aspect of an embodiment of the present invention, a UAV is provided, the UAV includes a fuselage and at least one camera module described in any one of the above, the camera module is arranged on the fuselage, and the lens module in the lens assembly can protrude from the body or retract into the body.

Various embodiments of the present invention provide at least the following beneficial effects. The camera module provided by an embodiment of the present invention includes: a mounting frame, a lens assembly and a driving mechanism. Wherein, the lens assembly and the driving mechanism are both arranged on the mounting frame. The lens assembly includes at least two lens modules. The lens assembly can move relative to the mounting frame, and the driving mechanism is used to control the movement of the lens module. The driving mechanism includes a guide assembly, a transmission assembly and a driving part. Wherein, the guide assembly is arranged on the mounting frame, and the two lens modules are slidably matched with the guide assembly. The transmission assembly is in transmission connection with the two lens modules respectively. The driving part is in transmission connection with the transmission assembly, and the driving part is used to drive the two lens modules to move back and forth along the guide assembly respectively. When the driving part is activated, the driving part drives the transmission assembly to move, thereby driving the lens module to move, and during the movement of the lens module, the guide assembly guides the movement of the lens module. Through the above method, the embodiment of the present invention can drive at least two lens modules at the same time, which not only realizes the adjustment of the positions of multiple lens modules at the same time, but also enables the lens modules to be placed in a drone or other devices to protect the lens module from scratches when the lens modules are not in use.

### BRIEF DESCRIPTION OF THE DRAWINGS

In order to more clearly illustrate the specific embodiments of the present invention or the technical solutions in the prior art, the following will briefly introduce the drawings that need to be used in the description of the specific embodiments or the prior art. Throughout the drawings, similar elements or parts are generally identified by similar reference numerals. In the drawings, elements or parts are not necessarily drawn in actual scale.

FIG. 1 is a perspective view of a camera module provided by an embodiment of the present invention.

FIG. 2 is a schematic diagram of a camera module provided by an embodiment of the present invention that does not include a first lens module, a second lens module, a third lens module, and a fourth lens module.

FIG. 3 is another perspective view of FIG. 1.

FIG. 4 is a schematic diagram of a driving device in a camera module provided by an embodiment of the present invention.

### DETAILED DESCRIPTION

In order to facilitate the understanding of the present invention, various embodiments will be described in more detail below in conjunction with the accompanying drawings and specific embodiments. It should be noted that when an element is said to be “fixed” to another element, it may be directly on the other element, or there may be one or more intervening elements therebetween. When an element is referred to as being “connected to” another element, it can be directly connected to the other element or one or more intervening elements may be present therebetween. The terms “vertical”, “horizontal”, “left”, “right” and similar expressions are used in this specification for the purpose of description only.

Unless otherwise defined, all technical and scientific terms used in this specification have the same meaning as commonly understood by one of ordinary skill in the technical field of the invention. The terms used in the description of the present invention in this specification are only for the purpose of describing specific embodiments, and are not used to limit the present invention. The term “and/or” used in this specification includes any and all combinations of one or more of the associated listed items.

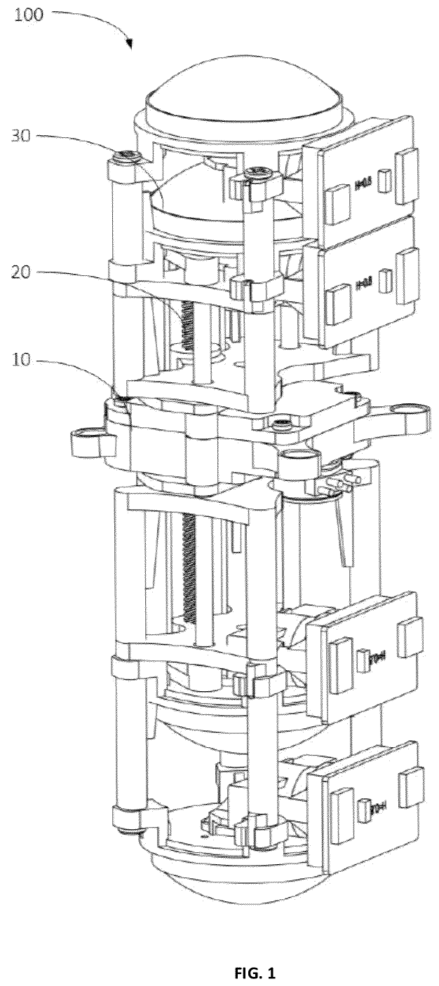

Referring to FIG. 1, a camera module 100 in accordance with an embodiment of the present invention includes: a mounting frame 10, a driving mechanism 20 and a lens assembly 30. As shown in FIG. 1, the driving mechanism 20 and the lens assembly 30 are both disposed on the mounting frame 10. The lens assembly 20 can move relative to the mounting frame 10, and the driving mechanism 20 is used to control the lens assembly 30 to protrude from the mounting frame 10 or retract back into the mounting frame 10. The lens assembly 30 includes at least two lens modules, so when the driving mechanism 20 is activated, the two lens modules can be driven to move back and forth along the guide assembly respectively. In this way, firstly, when the lens module is not in use, at least part of the lens module can be placed in the drone and other devices to protect the lens module. Secondly, when the drone and other devices move in one direction, it can retract the lens module into the device in that direction to protect the lens module (for example, when the drone lands, the bottom lens module can be stowed to protect the lens module). Moreover, because there is no need to reserve space for the entire lens module in the device, it can reduce the size of the device to meet the current demand for compact devices; and, because the lens module can be moved, it can also add more possibilities and provide more choices for the internal design and appearance design of the device.

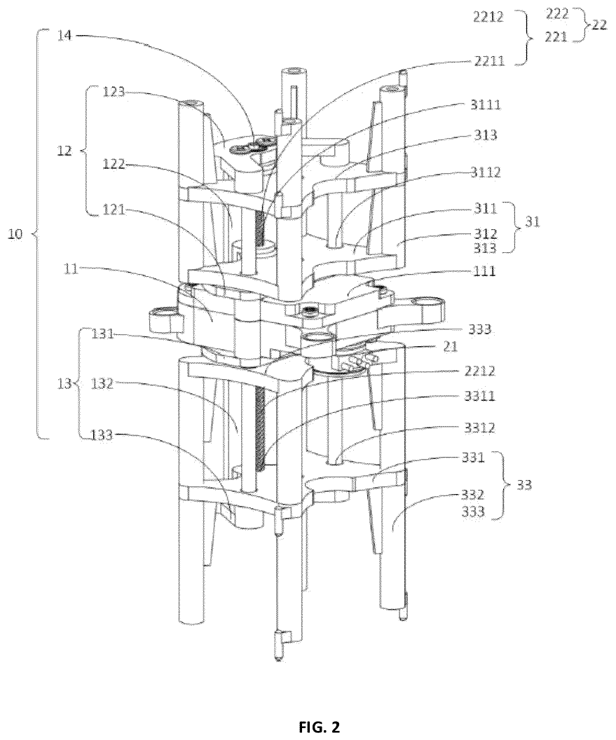

Referring to FIG. 2, in various embodiments, the mounting frame 10 can include a mounting block (or mounting base) 11, a first frame body 12 and a second frame body 13. The first frame body 12 is fixed on the first surface 111 of the mounting block 11, the second frame body 13 is fixed on the second surface (not shown) of the mounting block 11, and the first surface 111 is opposite to the second surface. Moreover, the first threaded rod 2211 and the first guide rod 231 (described below) are located on the first frame body 12, the second threaded rod 2212 and the second guide rod 232 (described below) are located on the second frame body 13. The transmission assembly 22 can be provided on the mounting block 11, the threaded rod 221 (described below) passes through the mounting block 11, and the threaded rod 221 can rotate relative to the mounting block 11.

The first frame body 12 includes the first base plate 121, a first connecting plate 122 and a first top plate 123. The first connecting plate 122 is connected with the first top plate 123 and the first base plate 121 respectively, and the first top plate 123 is set to be opposite to the first base plate 121. The mounting frame 10 also includes a first bearing 14. The first bearing 14 is fixed on the first top plate 123. The first base plate 121 is provided with a first through hole, and the first base plate 121 is fixed on the first surface 111 of the mounting block 11. The first thread rod 2211 passes through the first through hole and is sleeved in the first bearing 14. Both ends of the first guide rod 231 are fixed to the first base plate 121 and the first top plate 123 respectively.

The second frame body 13 includes a second base plate 131, a second connecting plate 132 and a second top plate 133. The second connecting plate 132 is connected with the second top plate 133 and the second base plate 131 respectively, and the second top plate 133 is set to be opposite to the second base plate 131. The mounting frame 10 also includes a second bearing, and the second bearing is fixed to the second top plate 133. The second base plate 131 is provided with a second through hole, and the second base plate 131 is fixed to the second surface of the mounting block 11. The second threaded rod 2212 passes through the second through hole and is sleeved in the second bearing. The two ends of the second guide rod 232 are fixed to the second base plate 131 and the second top plate 133 respectively.

It can be understood that, in other embodiments, the structure of the mounting block 11 is not limited thereto, as long as the driving mechanism 20 and the lens assembly 30 can be fixed. For example, the mounting block 11 and the first frame body 12 can be formed integrally with the second frame body 13, the transmission assembly 22, the first guide rod 231 and the second guide rod 232 can also be fixed.

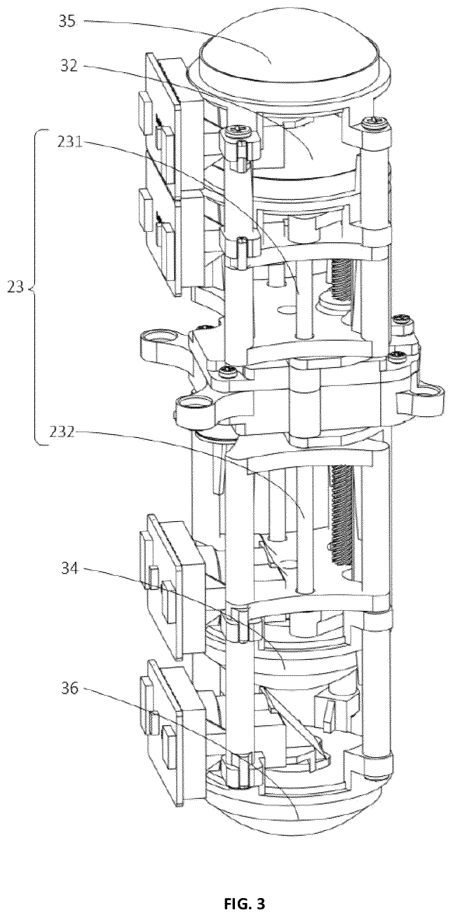

Details about the lens assembly 30 can be shown in FIG. 2 and FIG. 3. The lens assembly 30 includes a first lens mount 31, a first lens module 32, a second lens mount 33 and a second lens module 34. In one embodiment, the first lens module 32 and the second lens module 34 are disposed on the first lens mount 31 and the second lens mount 33 respectively.

Details about the first lens mount 31 can be shown in FIG. 2. The first lens mount 31 includes a first sliding plate 311 and a first supporting rod 312. The first sliding plate 311 is provided with a first screw hole 3111 and a first guide hole 3112. The first sliding plate 311 is located between the first top plate 123 and the first base plate 121. One end of the first support rod 312 is fixed on a surface of the first sliding plate 311 facing the first top plate 123, the other end of the first support rod 312 is fixed to the first lens 32.

In some embodiments, the number of the first support rods 312 can be multiple, and the multiple first support rods 312 are uniformly arranged on the periphery of the first sliding plate 311.

In various embodiments, the first lens mount 31 can further include a first limiting plate 313. One end of the first support rod 312 can be connected to the first sliding plate 311 and the first limiting plate 313 respectively, and both the first sliding plate 311 and the first limiting plate 313 can be located between the first top plate 123 and the first base plate 121. Moreover, the first limiting plate 313 can be provided with a third guide hole (not shown), and the first guide rod 231 passes through the third guide hole. Since the distance between the first top plate 123 and the first base plate 121 can be constant, the stroke distance of the first sliding plate 311 and the first limiting plate 313 can also be constant when moving. The setting of the first limiting plate 313 can limit the stroke distance of the first sliding plate 311 to a greater extent.

Details about the second lens mount 33 can be shown in FIG. 2. The second lens mount 33 includes a second sliding plate 331 and a second supporting rod 332. The second sliding plate 331 is provided with the second screw hole 3311 and the second guide hole 3312. The second sliding plate 331 can be located between the second top plate 133 and the second base plate 131, one end of the second support rod 332 can be fixed on a surface of the second sliding plate 331 facing the second top plate 133, and the other end of the second support rod 332 can be fixed to the second lens module 34.

In some embodiments, the number of the second support rods 332 can be multiple, and the multiple second support rods 332 can be uniformly arranged on the periphery of the second sliding plate 331.

In various embodiments, the second lens mount 33 further includes a second limiting plate 333, one end of the second support rod 332 can be connected to the second sliding plate 331 and the second limiting plate 333 respectively. Both the second sliding plate 331 and the second limiting plate 333 can be located between the second top plate 133 and the second base plate 131. Moreover, the second limiting plate 333 is provided with a fourth guide hole (not shown), and the second guide rod 232 passes through the fourth guide hole. Since the distance between the second top plate 133 and the second base plate 131 can be constant, the stroke distance of the second sliding plate 331 and the second limiting plate 333 can also be constant when moving, and the setting of the second limiting plate 333 can limit the stroke distance of the second sliding plate 331 to a greater extent.

In accordance with various embodiments, the lens assembly 30 also includes a third lens module 35 and a fourth lens module 36. As shown in FIG. 3, the third lens module 35 and the fourth lens module 36 can be fixed on the first support rod 312 and the second support rod 332 respectively. Along the direction in which the threaded rod 221 is set, the third lens module 35, the first lens module 32, the second lens module 34 and the fourth lens module 36 can be stacked to obtain images of more angle positions, so that the camera module 100 can obtain panoramic images with larger angles. It can be understood that the positional relationship between the first lens module 32, the second lens module 34, the third lens module 35 and the fourth lens module 36 is not limited thereto and the first lens module 32, the second lens module 34, the third lens module 35 and the fourth lens module 36 can be set according to the angular position required by the panoramic image.

In accordance with various embodiments, the third lens module 35 and the fourth lens module 36 are provided with a first support hole and a second support hole respectively, and the first support rod 312 and the second support rod 332 are provided with a third support hole and a fourth support hole respectively. The camera module 100 also includes a first screw and a second screw. The first screw is used to be inserted into the first support hole and screwed to the third support hole, and the second screw is used to be inserted into the second support hole and then screwed to the fourth support hole, so as to fix the third lens module 35 and the fourth lens module 36 on the first lens mount 31 and the second lens mount 33 respectively.

Details about the driving mechanism 20 can be shown in FIG. 2 to FIG. 4. The driving mechanism 20 includes a driving part 21, a transmission assembly 22 and a guide assembly 23. In one embodiment, the transmission assembly 22 is in transmission connection with the lens assembly 30, the guide assembly 23 is disposed on the mounting frame 10, and the guide assembly 23 is slidably connected with the lens assembly 30. The driving part 21 is in driving connection with the transmission assembly 22, and the driving part 21 is used to make the two lens modules in the lens assembly 30 approach or move away from each other.

In accordance with various embodiments, the driving part 21 can be fixed on the mounting block 11, and, in some embodiments, the driving part 21 is a motor, so as to be able to drive the transmission assembly 22.

In accordance with various embodiments, the transmission assembly includes a first threaded rod 2211, a second threaded rod 2212 and a speed change structure 222. The speed change structure 222 is provided with an input end and two output ends. The driving part 21 is connected to the input end of the speed change structure 222, and the two output ends of the speed change structure 222 are rotatably connected to the first threaded rod 2211 and the second threaded rod 2212 respectively. When the driver is activated, the speed change structure 222 can drive the first threaded rod 2211 and the second threaded rod 2212 to rotate relative to the mounting frame 10, and adjust the rotational speed of the first threaded rod 2211 and the second threaded rod 2212 in order to make the lens assembly 30 move at an appropriate speed.

In accordance with various embodiments, both the first threaded rod 2211 and the second threaded rod 2212 are rotatably set on the mounting frame 10. The first threaded rod 2211 is located on the first frame body 12, and the second threaded rod 2212 is located on the second frame body 13.

Furthermore, the first threaded rod 2211 can be screwed and passed through the first screw hole 3111. When the threaded rod 221 rotates, the first lens mount 31 can move, relative to the mounting frame 10, along the direction in which the first threaded rod 2211 is set.

Furthermore, the second threaded rod 2212 is screwed and passed through the second screw hole 3311. When the threaded rod 221 rotates, the second lens mount 33 can move, relative to the mounting frame 10, along the direction in which the second threaded rod 2212 is set.

It should be noted that the thread direction of the first threaded rod 2211 is set to be opposite to that of the second threaded rod 2212. For example, when the first threaded rod 2211 is provided with a forward thread, then the second threaded rod 2212 is provided with a reverse thread. Thus, the first lens mount 31 and the second lens mount 33 can approach the mounting frame 10 together or move away from the mounting frame 10 together. Thus, the first lens 32 and the second lens module 34 can approach the mounting frame 10 together or move away from the mounting frame 10 together.

In accordance with various embodiments, the leads of the first threaded rod 2211 and the second threaded rod 2212 are different, and the leads of the first threaded rod 2211 and the second threaded rod 2212 are set based on actual conditions. The situation is set, so that the end positions of the first lens module 32 and the second lens module 34 can be adjusted accordingly, so as to adjust the acquisition position of the holographic image.

In accordance with various embodiments, the first threaded rod 2211 and the second threaded rod 2212 can be connected to form a threaded rod 221. The threaded rod 221 is rotatably arranged on the mounting frame 10, and the threaded rod 221 includes a first threaded part, a rotating part and a second threaded part. The two ends of the rotating part are respectively connected with the first threaded part and the second threaded part, wherein the first threaded part and the second threaded part are respectively opposite on the first threaded rod 2211 and the second threaded rod 2212. When the driving part 21 is connected to the rotating part, it can also drive the threaded rod 221 to rotate, thereby driving the lens assembly 30 to move.

In accordance with various embodiments, the speed change structure 222 includes a speed change gear set 2221 and an output wheel 2222. The two ends of the speed change gear set 2221 are respectively connected with the driving part 21 and the output wheel 2222. The two ends of the output wheel 2222 are respectively connected with the first threaded rod 2211 and the second threaded rod 2212.

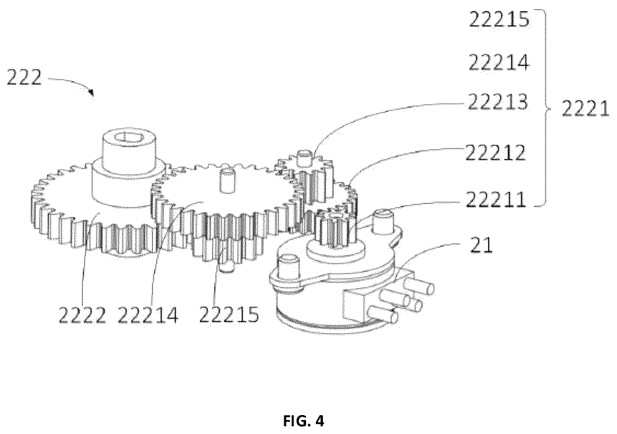

Referring to FIG. 4, in various embodiments, the speed change gear set 2221 includes a driving wheel 22211, a first driven wheel 22212, a second driven wheel 22213, a third driven wheel 22214 and a fourth driven wheel 22215. The driving wheel 22211 is connected to the output shaft of the driving part 21, the driving wheel 22211 meshes with the first driven wheel 22212, the first driven wheel 22212 is coaxially arranged with the second driven wheel 22213. The second driven wheel 22213 meshes with the third driven wheel 22214, the third driven wheel 22214 is coaxially arranged with the fourth driven wheel 22215, and the fourth driven wheel 22215 meshes with the output wheel 2222. When the driving part 21 is activated, the driving part 21 drives the driving wheel 22211 to move, thereby respectively driving the first driven wheel 22212, the second driven wheel 22213, the third driven wheel 22214, and the fourth driven wheel 22215 and the output wheel 2222 to move to realize the rotation of the first threaded rod 2211 and the second threaded rod 2212.

In accordance with various embodiments, the number of teeth of the output wheel 2222 can be greater than the number of teeth of the driving wheel 22211, so as to realize the deceleration of the transmission assembly 22 and prevent the camera module 100 from being damaged due to the impact of excessive rotation speed of the driving element 21.

In some embodiments, the transmission assembly 22 further includes a worm (not shown) and a worm wheel (not shown), the worm is connected to the driving part 21, the worm is meshed with the worm wheel, and the worm wheel is connected to the input end of the speed change structure 222, i.e., connected with the driving wheel 22221 of the speed change structure 222 in the above embodiment. When the driving part 21 is activated, the driving part 21 drives the worm to rotate, the worm drives the worm wheel to rotate, and the worm wheel rotates to drive the speed change structure 222 to move so as to play a speed changing or shifting role and can drive the first threaded rod 2211 and a second threaded rod 2212 to rotate.

In various embodiments, the speed change structure 222 further includes a first bevel gear (not shown), a second bevel gear (not shown) and a third bevel gear (not shown). Wherein, the first bevel gear, the second bevel gear and the third bevel gear are perpendicular to each other, the central axis of the second bevel gear coincides with the third bevel gear, and the output shaft of the speed change structure 222 is connected with the first bevel gear. The first bevel gear meshes with the second bevel gear and the third bevel gear respectively, and the second bevel gear and the third bevel gear are coaxially connected with the first threaded rod 2211 and the second threaded rod 2212 respectively. When driving part 21 is activated, the driving part 21 drives the worm gear and the worm to rotate. The rotation of the worm gear and the worm drives the speed change structure 222 to perform a speed change movement. The output end of the speed change structure 222 drives the first bevel gear to rotate. The first bevel gear respectively drives the second bevel gear and the third bevel gear to rotate, thereby driving the first threaded rod 2211 and the second threaded rod 2212 to rotate respectively.

It should be noted that the present invention lists some structures of the transmission assembly 22, but the structure of the transmission assembly 22 in the present invention is not limited thereto. For example, the driving of the threaded rod 221 can also be realized by changing the number of driven wheels in the above-mentioned speed change structure. In other embodiments, the above-mentioned speed change structure assembly, worm gear assembly and bevel gear assembly can be added or deleted according to actual needs. For example, if no speed change is required in actual use, the driving part 21 can be coaxially connected to the first threaded rod 2211 and the second threaded rod 2212 directly. For example, the worm can be directly connected with the output shaft of the driving part 21. When the worm meshes with the worm wheel and the worm wheel is sheathed on the threaded rod 221, it can also realize the driving of the lens assembly 30. Alternatively, the driving part 21 is connected to the first threaded rod 2211 and the second threaded rod 2212 through some other transmission components, such as a motor, a transmission wheel and a transmission chain. The transmission chain can be sleeved and engaged with the output shaft of the motor and the transmission wheel respectively. The transmission wheel is connected with the first threaded rod 2211 and the second threaded rod 2212, and the driving of the lens assembly 30 can also be realized when the motor is activated.

In accordance with various embodiments, as shown in FIG. 3, guide assembly 23 includes a first guide rod 231 and a second guide rod 232, both of which are disposed on the mounting frame 10.

In accordance with various embodiments, the first guide rod 231 is parallel to the first threaded rod 2211, and the first guide rod 231 passes through the first guide hole 3112 provided on the first lens mount 31. When the first lens mount 31 moves, the first lens mount 31 will be moved along the first guide rod, i.e., along the direction set for the first threaded rod 2211.

In accordance with various embodiments, the second guide rod 232 is parallel to the second threaded rod 2212, and the second guide rod 232 passes through the second guide hole 3312 provided on the second lens mount 33. When the second lens mount 33 moves, the second lens mount 33 will move along the second guide rod, i.e., the direction set for the second threaded rod 2212.

In various embodiments, the number of the first guide rod 231, the second guide rod 232, the first guide hole 3112 and the second guide hole 3312 are multiple, so that the guidance of the first lens mount 31 and the second lens mount 33 is more stable.

In various embodiments, the first guide rod 231 and the second guide rod 232 can be integrally formed to form one guide rod. As long as the two ends of the formed guide rod are respectively fixed to the mounting frame 10 and the guide rods are inserted into the first lens mount 31 and the second lens mount 33 respectively, the formed guide rod can guide the movement of the first lens mount 31 and the second lens mount 33.

When the transmission assembly 22 is activated, the transmission assembly 22 will drive the first threaded rod 2211 and the second threaded rod 2212 to rotate, so that the first lens mount 31 and the second lens mount 33 respectively move along the direction in which the first threaded rod 2211 and the second threaded rod 2212 are set to move. Since the thread directions of the first threaded rod 2211 and the second threaded rod 2212 are opposite, the first lens mount 31 and the second lens mount 33 can move away from the mounting frame 10 together and can also approach the mounting frame 10 together. And because the first guide rod 231 is plugged into the first lens mount 31 and the mounting frame 10 respectively, and the second guide rod 232 is plugged into the second lens mount 33 and the mounting frame 10 respectively, so that when the first lens mount 31 and the second lens mount 33 are in motion, the first lens mount 31 and the second lens mount 33 move along the directions of the first guide rod 231 and the second guide rod 232 respectively. Thus, the first guide rod 231 and the second guide rod 232 can guide the movement of the first lens mount 31 and the second lens mount 33, to make the movement of the first lens module 32 and the second lens module 34 more stable.

In accordance with various embodiments, a camera module 100 can include: a mounting frame 10, a lens assembly 30 and a driving mechanism 20. Wherein, the lens assembly 30 and the driving mechanism 20 are both disposed on the mounting frame 10. The lens assembly 30 includes at least two lens modules. The lens assembly 30 can move relative to the mounting frame 10, and the driving mechanism 20 can be used to control the movement of the lens module. The driving mechanism 20 includes a guide assembly 23, a transmission assembly 22 and a driving part 21. Wherein, the guide assembly 23 can be disposed on the mounting frame 10, and the two lens modules can be slidingly matched with the guide assembly 23. The transmission assembly 22 can be in transmission connection with the two lens modules respectively. The driving part 21 is in transmission connection with the transmission assembly 22, and the driving part 21 is used to drive the two lens modules to approach or move away from each other. When the driving part 21 is activated, the driving part 21 drives the transmission assembly 22 to move, thereby driving the lens module to move, and the guide assembly 23 can guide the movement of the lens module during the movement of the lens module. Through the above method, the embodiments of the present invention can realize the synchronous movement of at least two lens modules, which not only realizes the adjustment of the positions of the two lens modules at the same time, but also enables, when the lens modules are not in use, the lens module to be installed in devices such as drones to protect the lens module from scratches.

In accordance with various embodiments, a drone can include a fuselage and at least one camera module 100 described above, the camera module 100 can be arranged on the fuselage, and the lens module in the lens assembly 30 can protrude from the fuselage or retract into the fuselage. The camera module 100 can be installed in the drone for capturing images for the drone. Wherein, for the detailed structure of camera module 100, reference may be made to the above-mentioned embodiments, which will not be repeated here.

It should be noted that preferred embodiments of the present invention are provided in the description of the present invention and the accompanying drawings, but the present invention can be realized in many different forms and are not limited to the embodiments described in the description. These embodiments are not intended as additional limitations on the content of the present invention, and the purpose of providing these embodiments is to make the understanding of the disclosure of the present invention more thorough and comprehensive. Moreover, the above-mentioned technical features may continue to be combined with each other to form various embodiments that are not listed above, which are all regarded as the scope of the description of the present invention. Furthermore, for those of ordinary skill in the art, improvements or changes can be made according to the above description, and all these improvements and transformations should belong to the scope of protection of the appended claims of the present invention.

### LISTING OF DRAWING ELEMENTS

The reference numerals in the detailed description are as follows:

| | | | |
|---|---|---|---|
| 100 | camera module | 22214 | third driven wheel |
| 10 | mounting frame | 22215 | fourth driven wheel |
| 11 | mounting block | 2222 | output wheel |
| 111 | first surface | 23 | guide assembly |
| 12 | first frame | 231 | first guide rod |
| 121 | first base plate | 232 | second guide rod |
| 122 | first connecting plate | 30 | lens assembly |
| 123 | first top plate | 31 | first lens mount |
| 13 | second frame | 311 | first slide plate |
| 131 | second base plate | 3111 | first screw hole |
| 132 | second connecting plate | 3112 | first guide hole |
| 133 | second top plate | 312 | first support rod |
| 14 | first bearing | 313 | first limiting plate |
| 20 | driving mechanism | 32 | first lens module |
| 21 | driving part | 33 | second lens mount |
| 22 | transmission assembly | 331 | second sliding plate |
| 221 | threaded rod | 3311 | second screw hole |
| 2211 | first threaded rod | 3312 | second guide hole |
| 2212 | second threaded rod | 332 | second support rod |
| 222 | speed change structure | 333 | second limiting plate |
| 2221 | speed change gear set | 34 | second lens module |
| 22211 | driving wheel | 35 | third lens module |
| 22212 | first driven wheel | 36 | fourth lens module |
| 22213 | second driven wheel | | |

What is claimed is:

1. A camera module, comprising:
a mounting frame;
a lens assembly that is movably arranged on the mounting frame, wherein the lens assembly comprises two lens modules; and
a driving mechanism arranged on the mounting frame, wherein the driving mechanism comprises a guide assembly, a transmission assembly and a driving part,
wherein the guide assembly is arranged on the mounting frame and the two lens modules are slidably fitted to the guide assembly;
wherein the transmission assembly is in transmission connection with the two lens modules respectively, and
wherein the driving part is in transmission connection with the transmission assembly, and the driving part is used to drive the two lens modules to move back and forth along the guide assembly respectively.

2. The camera module according to claim 1, wherein the transmission assembly comprises:
a first threaded rod, wherein the first threaded rod is rotatably arranged on the mounting frame, and the first threaded rod is threadedly connected with a first lens module;
a second threaded rod, wherein the second threaded rod is rotatably arranged on the mounting frame, and the first threaded rod is threadedly connected with a second lens module; and
a speed change structure, wherein the speed change structure is provided with an input end and two output ends, the driving part is connected with the input end of the speed change structure, and the two output ends of the speed change structure are rotatably connected with the first threaded rod and the second threaded rod respectively, and wherein the speed change structure is used to adjust the rotational speeds of the first threaded rod and the second threaded rod.

3. The camera module according to claim 2, wherein:
the first threaded rod is provided with positive threads, and the second threaded rod is provided with reverse threads; and
the speed change structure comprises an output wheel and a speed change gear set, wherein the two ends of the speed change gear set are respectively connected with the driving part and the output wheel, and the two ends of the output wheel are connected with the first threaded rod and the second threaded rod respectively.

4. The camera module according to claim 2, wherein the speed change structure comprises a first bevel gear, a second bevel gear, a third bevel gear and a speed change gear set, and wherein one end of the speed change gear set is connected to the driving part, the other end of the transmission gear set is connected with the first bevel gear, the first bevel gear is engaged with the second bevel gear and the third bevel gear respectively, and the second bevel gear is connected with the first threaded rod, and the third bevel gear is connected with the second threaded rod.

5. The camera module according to claim 2, wherein the transmission assembly comprises a worm gear and a worm, and wherein the worm is connected to the driving part, the worm is meshed with the worm gear, and the worm gear is connected with the input end of the speed change structure.

6. The camera module according to claim 2, wherein:
the lens assembly comprises a first lens frame and a second lens frame, the first lens frame is provided with a first lens module, and the second lens frame is provided with a second lens module, and
wherein the first lens mount is provided with a first screw hole and the first threaded rod is screwed and passes through the first screw hole, and wherein the second lens mount is provided with a second screw hole and the second threaded rod is screwed and passes through the second screw hole.

7. The camera module according to claim 6, wherein:
the guide assembly comprises a first guide rod, wherein the first guide rod is fixed to the mounting frame and the first guide rod is parallel to the first screw thread rod, and wherein the first lens mount is provided with a first guide hole and the first guide rod passes through the first guide hole.

8. The camera module according to claim 7, wherein:
the first lens mount comprises a first sliding plate and a first support rod, the first screw hole and the first guide hole are both arranged on the first sliding plate,
wherein the first sliding plate and the first limiting plate are both located between the first top plate and the first base plate of the mounting frame, and wherein one end of the first support rod is fixed to a surface of the first sliding plate facing the first top plate of the mounting frame, and another end of the first support rod is fixed with the first lens module.

9. The camera module according to claim 8, wherein:
the first lens mount includes a first limiting plate, wherein one end of the first support rod is connected to the first sliding plate and the first limiting plate respectively, and wherein the first sliding plate and the first limiting plate are located between the first top plate and the first base plate of the mounting frame, and
wherein the first limiting plate is provided with a third guide hole, and the first guide rod passes through the third guide hole.

10. An unmanned aerial vehicle, comprising:
a fuselage; and
at least one camera module, wherein the camera module comprises:
a mounting frame;
a lens assembly that is movably arranged on the mounting frame, wherein the lens assembly comprises two lens modules; and
a driving mechanism arranged on the mounting frame, wherein the driving mechanism comprises a guide assembly, a transmission assembly and a driving part,
wherein the guide assembly is arranged on the mounting frame and the two lens modules are slidably fitted to the guide assembly;
wherein the transmission assembly is respectively connected to the transmission of the two lens modules,
wherein the driving part is in transmission connection with the transmission assembly, and the driving part is used to respectively drive the two lens modules to move back and forth along the guide assembly, and
wherein the camera module is arranged on the fuselage, and the lens module in the lens assembly can protrude from the fuselage or retract into the fuselage.

11. A camera module, comprising:
a mounting frame;
a lens assembly that is movably arranged on the mounting frame, wherein the lens assembly comprises two lens modules; and
a driving mechanism arranged on the mounting frame, wherein the driving mechanism comprises a guide assembly and a driving part,
wherein the guide assembly is arranged on the mounting frame and the two lens modules are slidably fitted to the guide assembly; and
wherein the driving part is in transmission connection with the two lens modules, and the driving part drives the two lens modules to move back and forth along the guide assembly and controls the lens assembly to protrude from the mounting frame or retract back into the mounting frame.

12. The camera module according to claim 11, wherein the driving mechanism further comprises a transmission assembly that connects to the driving part and the two lens modules respectively.

13. The camera module according to claim 12, wherein the transmission assembly comprises:
a first threaded rod, wherein the first threaded rod is rotatably arranged on the mounting frame, and the first threaded rod is threadedly connected with a first lens module;
a second threaded rod, wherein the second threaded rod is rotatably arranged on the mounting frame, and the first threaded rod is threadedly connected with a second lens module; and
a speed change structure, wherein the speed change structure is provided with an input end and two output ends, the driving part is connected with the input end of the speed change structure, and the two output ends of the speed change structure are rotatably connected with the first threaded rod and the second threaded rod respectively, and wherein the speed change structure is used to adjust the rotational speeds of the first threaded rod and the second threaded rod.

14. The camera module according to claim 13, wherein:
the first threaded rod is provided with positive threads, and the second threaded rod is provided with reverse threads; and
the speed change structure comprises an output wheel and a speed change gear set, wherein the two ends of the speed change gear set are respectively connected with the driving part and the output wheel, and the two ends of the output wheel are connected with the first threaded rod and the second threaded rod respectively.

15. The camera module according to claim 13, wherein the transmission assembly comprises a worm gear and a worm, and wherein the worm is connected to the driving part, the worm is meshed with the worm gear, and the worm gear is connected with an input end of the speed change structure.

16. The camera module according to claim 13, wherein:
the lens assembly comprises a first lens frame and a second lens frame, the first lens frame is provided with a first lens module, and the second lens frame is provided with a second lens module, and
wherein the first lens mount is provided with a first screw hole and the first threaded rod is screwed and passes through the first screw hole, and wherein the second lens mount is provided with a second screw hole and the second threaded rod is screwed and passes through the second screw hole.

17. The camera module according to claim 16, wherein:
the guide assembly comprises a first guide rod, wherein the first guide rod is fixed to the mounting frame and the first guide rod is parallel to the first screw thread rod, and wherein the first lens mount is provided with a first guide hole and the first guide rod passes through the first guide hole.

18. The camera module according to claim 17, wherein:
the first lens mount comprises a first sliding plate and a first support rod, the first screw hole and the first guide hole are both arranged on the first sliding plate,
wherein the first sliding plate and the first limiting plate are both located between the first top plate and the first base plate of the mounting frame, and wherein one end of the first support rod is fixed to a surface of the first sliding plate facing the first top plate of the mounting frame, and another end of the first support rod is fixed with the first lens module.

19. The camera module according to claim 18, wherein:
the first lens mount includes a first limiting plate, wherein one end of the first support rod is connected to the first sliding plate and the first limiting plate respectively, and the first sliding plate and the first limiting plate are located between the first top plate and the first base plate of the mounting frame, and
wherein the first limiting plate is provided with a third guide hole, and the first guide rod passes through the third guide hole.

20. The camera module according to claim 11, wherein the driving part drives the two lens modules to move back and forth at opposite directions along the guide assembly.
